(19) United States
(12) Patent Application Publication
(10) Pub. No.: US 2016/0337593 A1
(43) Pub. Date: Nov. 17, 2016

(54) IMAGE PRESENTATION METHOD, TERMINAL DEVICE AND COMPUTER STORAGE MEDIUM

(71) Applicant: ZTE CORPORATION, Shenzhen, Guangdong (CN)

(72) Inventor: Yanling Guo, Shenzhen (CN)

(21) Appl. No.: 15/110,236

(22) PCT Filed: May 6, 2014
(86) PCT No.: PCT/CN2014/076891

§ 371 Date: Jul. 7, 2016

(30) Foreign Application Priority Data
Jan. 16, 2014 (CN) 201410020015.4

(51) Int. Cl. H04N 5/232; H04N 1/21

(52) U.S. Cl. CPC H04N 5/23293; H04N 5/23216; H04N 5/23219; H04N 1/2137; H04N 1/2133

(57) ABSTRACT

An image presentation method, a terminal device and a computer storage medium are described. The method includes that: an area target selected by a user within a full image of framing in a photographic preview stage is acquired; the area target selected by the user is instantly and continuously presented according to an effect set by the user; and the area target selected by the user is stored and presented according to the effect set by the user. The present disclosure locks an area target of interest to a user within a full image of framing in a preview stage, and meets visual requirements of the user for a real-time special effect on the area target in a differentiated and diversified way. The present disclosure achieves an innovative expansion of a photographic function mode of a terminal, fills in the blanks of instantly previewing and photographing a special effect on an area target by the terminal, and obtains a new photographic special effect style and an instant image, thereby enriching a photographic experience.

### TECHNICAL FIELD

The present disclosure relates to the technical field of terminal devices, and more particularly, to an image presentation method, a terminal device and a computer storage medium.

### BACKGROUND

Currently, many terminal devices are equipped with cameras, which support general functions such as photographing focusing, colour setting and special effect application. However, the implementation of these functions on each existing terminal camera proceeds from a full image of overall preview framing based on execution processing of global information, and an effect action is embodied in a full range of preview of a photographed picture.

User habits and personal preferences are different, so when cameras are used, instant special effects such as area focusing improvement or object fuzzification, area overturn or object rotation, area replacement or object replication and colour removal or addition on a certain local area or specific object within a full image of preview framing will be required. However, a specific area or a specific object of interest to a user in preview framing is not processed instantly in a targeted way in the related art, processing after photographing cannot completely meet requirements of the user, and an implementation result is not ideal.

### SUMMARY

The present disclosure provides an image presentation method, a terminal device and a computer storage medium, which are intended to solve technical problems about special effect processing on a local area within a full image of preview framing and instant and continuous presentation.

The technical solutions are adopted in embodiments of the present disclosure as follows. An image presentation method includes that:

an area target selected by a user within a picture in a preview stage is acquired;

the area target selected by the user is instantly and continuously presented according to an effect set by the user.

Preferably, the step that the area target selected by the user within the picture in the preview stage is acquired may include the steps as follows.

An initial area selection frame is provided for the user, and a position and/or size of the area selection frame are/is adjusted according to an operation of the user, wherein a coverage range of the adjusted area selection frame is the area target.

Or,

A profile of each object subject within a full image of preview framing is determined based on a shape edge detection algorithm to allow the user to select an object subject of interest therefrom, wherein the selected object subject is the area target.

Or,

An initial area selection frame is provided for the user, a position and/or size of the area selection frame are/is adjusted according to an operation of the user, and a profile of each object subject within a full image of preview framing is determined in the area selection frame based on a shape edge detection algorithm to allow the user to select an object subject of interest therefrom, wherein the selected object subject is the area target.

Preferably, the process that the initial area selection frame is provided for the user may include the steps as follows.

A default position starting point is set within the picture in the preview stage, a position at the starting point is moved to a position point of interest to the user based on the operation of the user or by capturing movement of eyes, gazing at a focus, of the user, and the initial area selection frame is provided for the user at the position point of interest to the user.

Preferably, the step that the area target selected by the user is instantly and continuously presented according to the effect set by the user may include the steps as follows.

The area target selected by the user is tracked in real time by comparing collected image frames, and display is continuously performed within the tracked area target according to the effect set by the user.

Preferably, the step that the area target selected by the user is tracked in real time by comparing the collected image frames may include the steps as follows.

A position of the area target within a current image frame is compared with a position of the area target within a preceding image frame based on the collected continuous image frames so as to track and locate a position change of the area target in real time.

Preferably, the preceding image frame may include: a previous frame of image with respect to the current image frame or previous frames of images with respect to the current image frame.

The current image frame may include: image frames, selected in the collected continuous image frames as current image frames, at set intervals.

Preferably, the effect set by the user may be in one or more types of: focusing enhancement or fuzzification, overturn or rotation, zooming in or out, replacement or replication, colour removal or addition and photographing parameter setting.

Preferably, as an optional technical solution, the method may further include the step as follows.

The area target selected by the user is stored and presented according to the effect set by the user based on a trigger operation of the user.

Preferably, as an optional technical solution, the method may further include the steps as follows.

The area target selected by the user is pre-photographed and stored in the preview stage at a set time interval according to the effect set by the user. If a difference between a picture photographed by the user and a pre-photographed picture does not exceed a set threshold, the pre-photographed picture is directly applied as a picture finally photographed by the user.

According to an embodiment of the present disclosure, a terminal device is also provided, which includes that:

an area target selection module, configured to acquire an area target selected by a user within a picture in a preview stage; and

a real-time preview effect presentation module, configured to instantly and continuously present the area target selected by the user according to an effect set by the user.

Preferably, the area target selection module may include:

an initial area provision module, configured to provide an initial area selection frame for the user; and

an area target determination module, configured to adjust a position and/or size of the area selection frame according to an operation of the user, wherein a coverage range of the adjusted area selection frame is the area target.

Or, the area target selection module may include:

an area target determination module, configured to determine a profile of each object subject within a full image of preview framing based on a shape edge detection algorithm to allow the user to select an object subject of interest therefrom, wherein the selected object subject is the area target.

Or, the area target selection module may include:

an initial area provision module, configured to provide an initial area selection frame for the user; and

an area target determination module, configured to adjust a position and/or size of the area selection frame according to an operation of the user, and determine a profile of each object subject within a full image of preview framing in the area selection frame based on a shape edge detection algorithm to allow the user to select an object subject of interest therefrom, wherein the selected object subject is the area target.

Preferably, the initial area provision module may be configured to:

set a default position starting point within the picture in the preview stage, move a position at the starting point to a position point of interest to the user based on the operation of the user or by capturing movement of eyes, gazing at a focus, of the user, and provide the initial area selection frame for the user at the position point of interest to the user.

Preferably, the real-time preview effect presentation module may include:

a tracking module, configured to track the area target selected by the user in real time by comparing collected image frames; and

a display module, configured to continuously perform display within the tracked area target according to the effect set by the user.

Preferably, the tracking module may be configured to:

compare a position of the area target within a current image frame with a position of the area target within a preceding image frame based on the collected continuous image frames so as to track and locate a position change of the area target in real time.

Preferably, the preceding image frame may include: a previous frame of image with respect to the current image frame or previous frames of images with respect to the current image frame.

The current image frame may include: image frames, selected in the collected continuous image frames as current image frames, at set intervals.

Preferably, the effect set by the user may be in one or more types of: focusing enhancement or fuzzification, overturn or rotation, zooming in or out, replacement or replication, colour removal or addition and photographing parameter setting.

Preferably, as an optional technical solution, the terminal device may further include:

a photographing processing module, configured to store and present the area target selected by the user according to the effect set by the user based on a trigger operation of the user.

Preferably, as an optional technical solution, the terminal device may further include:

a photographing processing module, configured to pre-photograph and store the area target selected by the user in the preview stage at a set time interval according to the effect set by the user, and directly apply, if a difference between a picture photographed by the user and a pre-photographed picture does not exceed a set threshold, the pre-photographed picture as a picture finally photographed by the user.

According to an embodiment of the present disclosure, a computer storage medium is also provided. Computer executable instructions are stored therein and configured to execute the above method.

By means of the image presentation method, the terminal device and the computer storage medium according to the embodiments of the present disclosure, an area target of interest to a user may be locked within a full image of framing in a preview stage, and visual requirements of the user for a real-time special effect on the area target are met in a differentiated and diversified way. The method and the terminal device according to the embodiments of the present disclosure may achieve an innovative expansion of a photographic function mode of a terminal, fill in the blanks of instantly previewing and photographing a special effect on an area target by the terminal, and obtain a new photographic special effect style and an instant image, thereby enriching a photographic experience.

### BRIEF DESCRIPTION OF THE DRAWINGS

FIG. 1 is a flow chart of an image presentation method according to a first embodiment of the present disclosure;

FIG. 2 is a flow chart of an image presentation method according to a second embodiment of the present disclosure;

FIG. 3 is a composition structure diagram of a terminal device according to third and fourth embodiments of the present disclosure;

FIG. 4(a) is a structural diagram of first and third implementations for an area target selection module in third and fourth embodiments of the present disclosure;

FIG. 4(b) is a structural diagram of a second implementation for an area target selection module in third and fourth embodiments of the present disclosure;

FIG. 5 is a composition structure diagram of a real-time preview effect presentation module in third and fourth embodiments of the present disclosure;

FIG. 6 is a diagram of a process for controlling photographing of a terminal device by a user via a touch screen according to an application example of the present disclosure;

FIG. 7 is a diagram of determination conditions of a point of interest to a user and a target area position according to an application example of the present disclosure; and

FIG. 8 is a diagram of comparison between effects on a terminal device before and after photographing according to an application example of the present disclosure.

### DETAILED DESCRIPTION

In order to further elaborate technical means and effects adopted in the present disclosure to achieve predetermined purposes, the present disclosure will be illustrated in detail together with the accompanying drawings and preferred embodiments as follows.

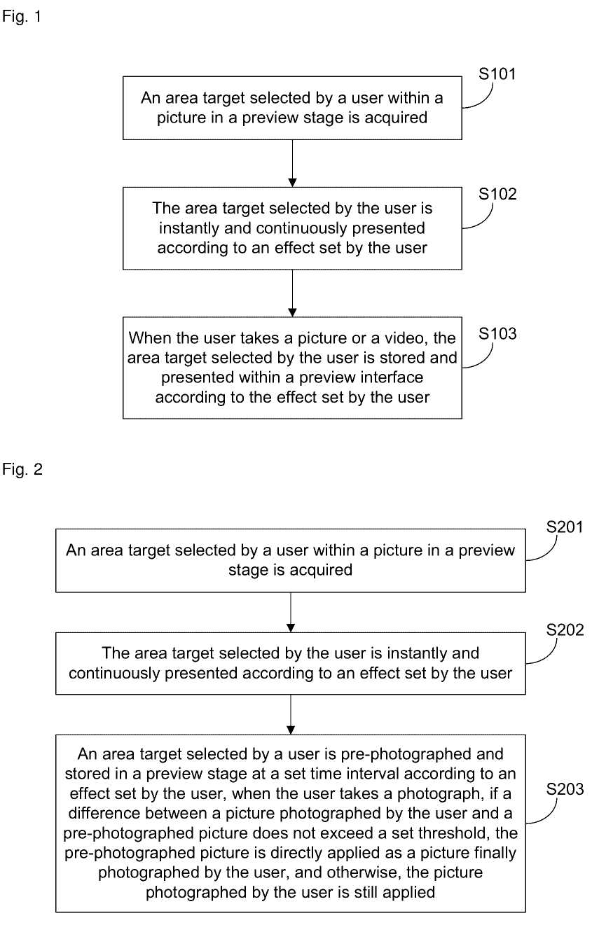

As shown in FIG. 1, according to a first embodiment of the present disclosure, an image presentation method includes the steps as follows.

Step S101: an area target selected by a user within a picture in a preview stage is acquired.

Preferably, step S101 includes the following acquisition modes:

providing an initial area selection frame for the user, and adjusting a position and/or size of the area selection frame according to an operation of the user, wherein a coverage range of the adjusted area selection frame is the area target;

or,

determining a profile of each object subject within a full image of preview framing based on a shape edge detection algorithm to allow the user to select an object subject of interest therefrom, wherein the selected object subject is the area target;

or,

providing an initial area selection frame for the user, adjusting a position and/or size of the area selection frame according to an operation of the user, and determining a profile of each object subject within a full image of preview framing in the area selection frame based on a shape edge detection algorithm to allow the user to select an object subject of interest therefrom, wherein the selected object subject is the area target.

In the above acquisition modes, the operations of the user may be diversified. By taking input on a touch screen as an example, the user may zoom out and in the area selection frame by inward closing and outward sliding of two fingers. The area selection frame may be square or round. The shape edge detection algorithm may be selected from the following classic algorithms: a Roberts algorithm, a Sobel algorithm, a Prewitt algorithm, a Krisch algorithm, a Gauss-Laplace algorithm and the like.

In the above acquisition modes, the process that the initial area selection frame is provided for the user includes that: a default position starting point is set within a preview picture, wherein a position at the starting point is usually located in a centre of the full image; the position at the starting point is moved to a position point of interest to the user based on the operation of the user or by capturing movement of eyes, gazing at a focus, of the user; and the initial area selection frame is provided for the user at the position point of interest to the user.

Step s102: The area target selected by the user is instantly and continuously presented according to an effect set by the user.

Preferably, Step S102 includes the steps as follows.

The area target selected by the user is tracked in real time by comparing collected image frames, and display is continuously performed within the tracked area target according to the effect set by the user.

Preferably, a position of the area target within a current image frame is compared with a position of the area target within a preceding image frame based on the collected continuous image frames so as to track and locate a position change of the area target in real time and to track the area target selected by the user in real time.

In this embodiment, the preceding image frame includes: a previous frame of image with respect to the current image frame or previous frames of images with respect to the current image frame. The current image frame includes: image frames, selected in the collected continuous image frames as current image frames, at set intervals. For example, a next frame with respect to every five frames serves as a current image frame namely a first frame, a sixth frame and an eleventh frame, which are compared with preceding image frames in sequence respectively. If each frame of image is compared with a previous frame of image, a displacement of the area target can be accurately and timely tracked. However, processing of each frame of image probably lays a heavy burden on a system. In the case of taking tracking efficiency and system burdens into consideration, an image frame after a certain interval may be properly selected as a current frame to be compared with a previous frame of image. In order to make the tracking accuracy higher, the current frame may be compared with previous frames of images, and tracking of the area target is directed according to a comprehensive comparison result.

When the area target selected by the user is the coverage range of the adjusted area selection frame, the position change of the area target is reflected by a position offset of an image centre point or edge point of the area target. When the area target is the object subject selected by the user, the position change of the area target is reflected by a position offset of a set point on a profile of the area target. For example, coordinate positions of next pixel points at intervals of every 15 pixel points on the profile of the area target are compared to judge whether the position of the area target changes.

Preferably, the effect set by the user may be in one or more types of: focusing enhancement or fuzzification, overturn or rotation, zooming in or out, replacement or replication, colour removal or addition and photographing parameter setting. The overturn or rotation effect includes: left-right rotation, up-down rotation, rotation based on a 45-degree sector and the like. An applicable colour effect includes: a black-white effect, a retro effect, a colour cast effect, a negative film effect, a print effect, and the like. Set photographing parameters include: selection scenarios, brightness, contrast, exposure, saturation, photo-sensibility, white balance and the like.

The above steps S101 to S102 can already be used as an embodiment of a complete technical solution of the present disclosure.

Preferably, the method further includes the step as follows.

Step S103: When the user takes a picture or a video, the area target selected by the user is stored and presented within a preview interface according to the effect set by the user. Here, picture or video taking may be interpreted as that only the area target is photographed and stored or the area target may be displayed by photographing a full image according to the effect set by the user.

According to a second embodiment of the present disclosure, an image presentation method is provided. As shown in FIG. 2, steps S201 to S202 in this embodiment are substantially identical to steps S101 to S102 in the first embodiment. Differently, the method in the embodiment further includes the step as follows.

Step S203: an area target selected by a user is pre-photographed and stored in a preview stage at a set time interval according to an effect set by the user. Preferably, a picture result stored during pre-photographing at each time covers or replaces a picture result stored during previous pre-photographing. If a storage space is sufficient, picture results stored during pre-photographing for many times can be reserved simultaneously, and then can be aged and deleted in sequence.

When the user takes a photograph, if a difference between a picture photographed by the user and a pre-photographed picture does not exceed a set threshold, the pre-photographed picture is directly applied as a picture finally photographed by the user. Otherwise, the picture photographed by the user is still applied.

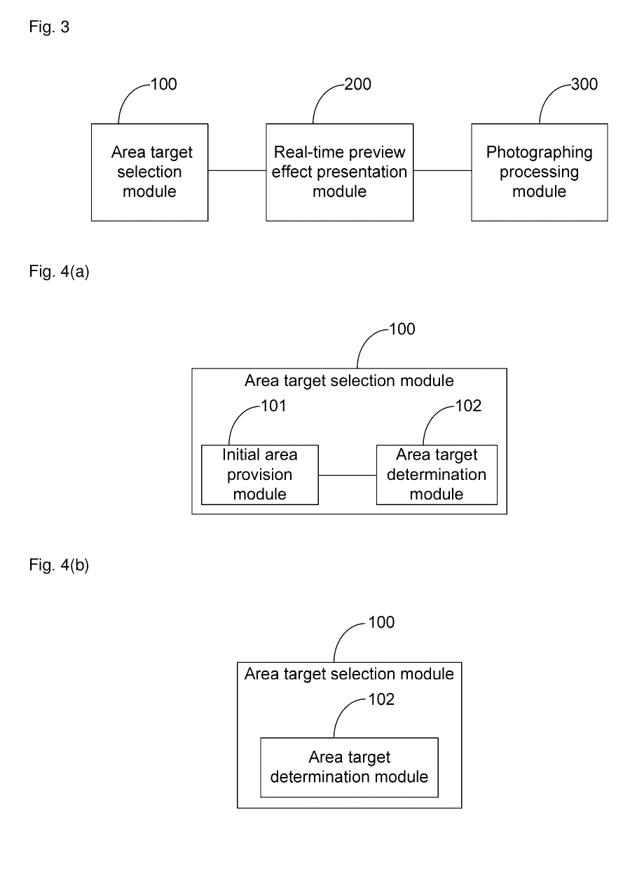

As shown in FIG. 3, according to a third embodiment of the present disclosure, in correspondence to the method in the first embodiment, a terminal device is provided, which includes the following components:

1) an area target selection module 100, configured to acquire an area target selected by a user within a picture in a preview stage, wherein

preferably, the area target selection module 100 adopts the following implementations:

a first implementation: as shown in FIG. 4(a), the area target selection module 100 includes:

an initial area provision module 101, configured to provide an initial area selection frame for the user, and

an area target determination module 102, configured to adjust a position and/or size of the area selection frame according to an operation of the user, wherein a coverage range of the adjusted area selection frame is the area target;

a second implementation: as shown in FIG. 4(b), the area target selection module 100 includes:

an area target determination module 102, configured to determine a profile of each object subject within a full image of preview framing based on a shape edge detection algorithm to allow the user to select an object subject of interest therefrom, wherein the selected object subject is the area target;

a third implementation: as shown in FIG. 4(a), the area target selection module 100 includes:

an initial area provision module 101, configured to provide an initial area selection frame for the user, and

an area target determination module 102, configured to adjust the position and/or size of the area selection frame according to an operation of the user, and determine a profile of each object subject within a full image of preview framing in the area selection frame based on a shape edge detection algorithm to allow the user to select an object subject of interest therefrom, wherein the selected object subject is the area target;

in the above implementations, the initial area provision module 101 is configured to:

set a default position starting point within a preview picture, move the position at the starting point to a position point of interest to the user based on the operation of the user or by capturing movement of eyes, gazing at a focus, of the user; and provide the initial area selection frame for the user at the position point of interest to the user; and

2) a real-time preview effect presentation module 200, configured to instantly and continuously present the area target selected by the user according to an effect set by the user;

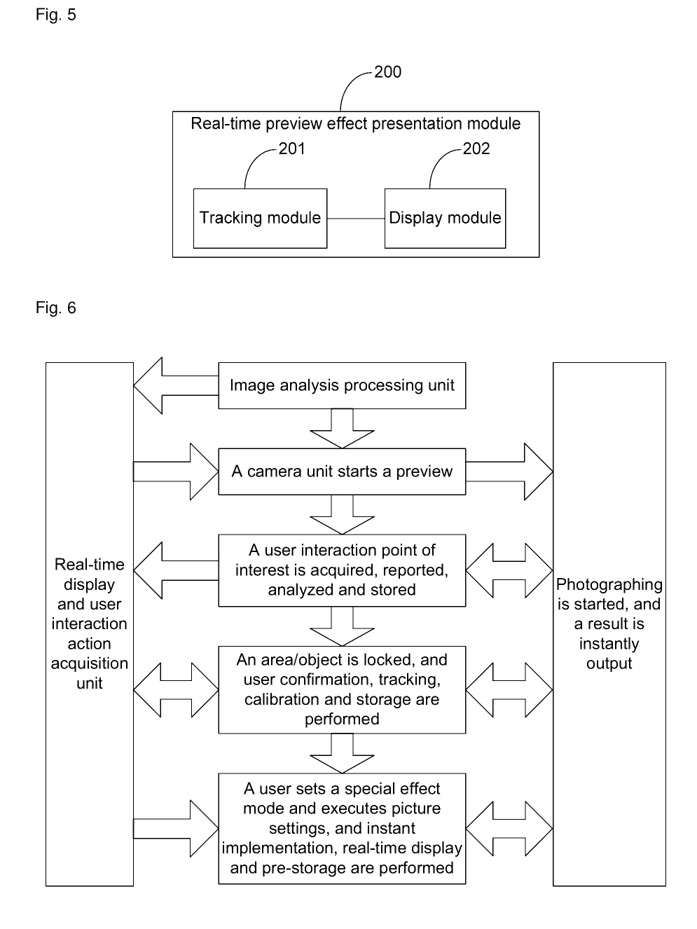

preferably, as shown in FIG. 5, the real-time preview effect presentation module 200 includes:

a tracking module 201, configured to track the area target selected by the user in real time by comparing collected image frames, and

a display module 202, configured to continuously perform display within the tracked area target according to the effect set by the user.

Preferably, the tracking module 201 is configured to: compare a position of the area target within a current image frame with a position of the area target within a preceding image frame based on the collected continuous image frames so as to track and locate a position change of the area target in real time.

In this embodiment, the preceding image frame includes: a previous frame of image with respect to a current image frame or previous frames of images with respect to the current image frame. The current image frame includes: image frames, selected in the collected continuous image frames as current image frames, at set intervals. For example, a next frame with respect to every five frames serves as a current image frame namely a first frame, a sixth frame and an eleventh frame, which are compared with preceding image frames in sequence respectively. If each frame of image is compared with a previous frame of image, a displacement of the area target can be accurately and timely tracked. However, processing of each frame of image probably lays a heavy burden on a system. In the case of taking tracking efficiency and system burdens into consideration, an image frame after a certain interval may be properly selected as a current frame to be compared with a previous frame of image. In order to make the tracking accuracy higher, the current frame may be compared with previous frames of images, and tracking of the area target is directed according to a comprehensive comparison result.

When the area target selected by the user is the coverage range of the adjusted area selection frame, the position change of the area target is reflected by a position offset of an image centre point or edge point of the area target. When the area target is the object subject selected by the user, the position change of the area target is reflected by a position offset of a set point on a profile of the area target. For example, coordinate positions of next pixel points at intervals of every 15 pixel points on the profile of the area target are compared to judge whether the position of the area target changes.

Preferably, the effect set by the user may be in one or more types of: focusing enhancement or fuzzification, overturn or rotation, zooming in or out, replacement or replication, colour removal or addition and photographing parameter setting. The overturn or rotation effect includes: left-right rotation, up-down rotation, rotation based on a 45-degree sector and the like. An applicable colour effect includes: a black-white effect, a retro effect, a colour cast effect, a negative film effect, a print effect, and the like. Set photographing parameters include: selection scenarios, brightness, contrast, exposure, saturation, photo-sensibility, white balance and the like.

The above area target selection module 100 and real-time preview effect presentation module 200 can already be used as an embodiment of a complete technical solution of the present disclosure.

Preferably, the terminal device further includes:

3) a photographing processing module 300, configured to store and present, when the user takes a picture or a video, the area target selected by the user within a preview interface according to the effect set by the user, wherein picture or video taking here may be interpreted as that only the area target is photographed and stored or the area target may be displayed by photographing a full image according to the effect set by the user.

According to a fourth embodiment of the present disclosure, in correspondence to the method in the second embodiment, a terminal device is provided. As shown in FIG. 3, functions of the area target selection module 100 and the real-time preview effect presentation module 200 in the embodiment are substantially identical to functions recorded in the third embodiment. Differently, a photographing processing module 300 of the terminal device in this embodiment is configured to pre-photograph and store an area target selected by a user in a preview stage at a set time interval according to an effect set by the user. Preferably, a picture result stored during pre-photographing at each time covers or replaces a picture result stored during previous pre-photographing. If a storage space is sufficient, picture results stored during pre-photographing for many times can be reserved simultaneously, and then can be aged and deleted in sequence.

When the user takes a photograph, if a difference between a picture photographed by the user and a pre-photographed picture does not exceed a set threshold, the pre-photographed picture is directly applied as a picture finally photographed by the user. Otherwise, the picture photographed by the user is still applied.

According to an embodiment of the present disclosure, a computer storage medium is also provided. Computer executable instructions are stored therein and are configured to execute the above method.

All modules may be implemented by a Central Processing Unit (CPU), a Digital Signal Processor (DSP) or a Field-Programmable Gate Array (FPGA) in an electronic device.

Those skilled in the art shall understand that the embodiments of the present disclosure may be provided as a method, a system or a computer program product. Thus, forms of hardware embodiments, software embodiments or embodiments integrating software and hardware may be adopted in the present disclosure. Moreover, a form of the computer program product implemented on one or more computer available storage media (including, but are not limited to, a disk memory, an optical memory and the like) containing computer available program codes may be adopted in the present disclosure.

The present disclosure is described with reference to flow charts and/or block diagrams of the method, the device (system) and the computer program product according to the embodiments of the present disclosure. It will be appreciated that each flow and/or block in the flow charts and/or the block diagrams and a combination of the flows and/or the blocks in the flow charts and/or the block diagrams may be implemented by computer program instructions. These computer program instructions may be provided for a general computer, a dedicated computer, an embedded processor or processors of other programmable data processing devices to generate a machine, such that an apparatus for implementing functions designated in one or more flows of the flow charts and/or one or more blocks of the block diagrams is generated via instructions executed by the computers or the processors of the other programmable data processing devices.

These computer program instructions may also be stored in a computer readable memory capable of guiding the computers or the other programmable data processing devices to work in a specific mode, such that a manufactured product including an instruction apparatus is generated via the instructions stored in the computer readable memory, and the instruction apparatus implements the functions designated in one or more flows of the flow charts and/or one or more blocks of the block diagrams.

These computer program instructions may also be loaded to the computers or the other programmable data processing devices, such that processing implemented by the computers is generated by executing a series of operation steps on the computers or the other programmable devices, and therefore the instructions executed on the computers or the other programmable devices provide a step of implementing the functions designated in one or more flows of the flow charts and/or one or more blocks of the block diagrams.

Based on the above embodiments, by taking touch screen interaction as an example, an application example of the present disclosure is introduced below together with FIG. 6 to FIG. 8.

As shown in FIG. 6, a process of controlling photographing of a terminal device by a user via a touch screen is as follows.

1. Preview framing input is performed.

A photographing preview is started by a camera unit of a terminal device firstly.

2. Real-time display presentation is performed.

A current preview framing picture will be presented on a real-time display and user interaction action acquisition unit of the terminal device in real time.

3. A user interaction point of interest is acquired.

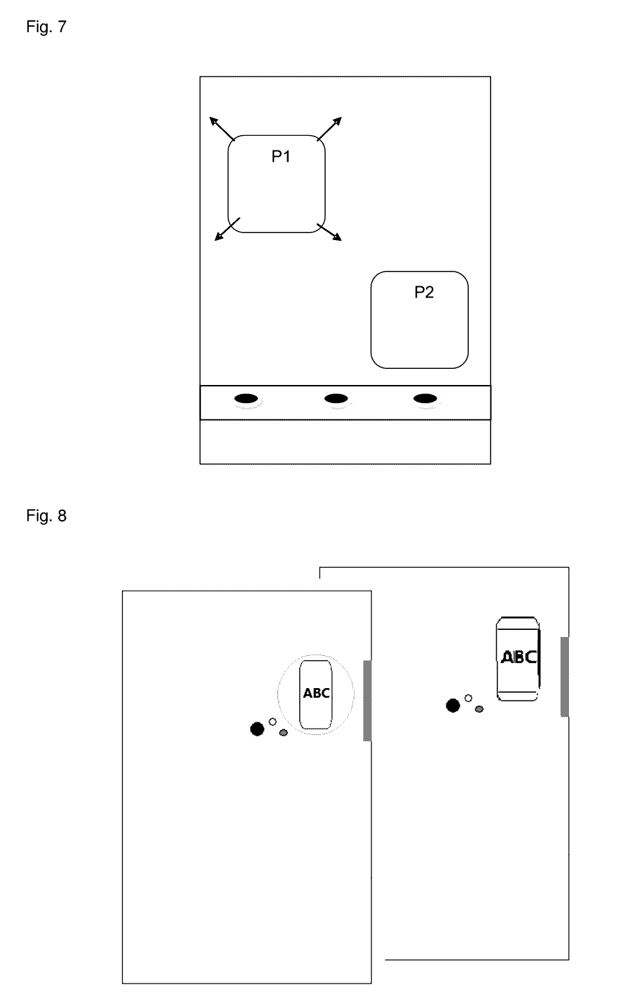

As shown in FIG. 7, a user may input a point of interest on a touch screen within a certain time after framing; preferably, a picture centre point is marked as a default starting point centre; the user may move the starting point to any target position, such as the position of a P1 point or a P2 point, of interest to the user in a framing picture by means of a certain mode of clicking, for example, a certain part of the touch screen, pressing a key to input coordinates or capturing movement of eyes gazing at a focus; and taking clicking and displaying of a certain part of the touch screen as an example, the real-time display and user interaction action acquisition unit will present a current selection of the user in real time to acquire a point of interest, and position information will be recorded and reported to an image analysis processing unit.

4. A target area object is locked, and information is analyzed, stored and reported.

As shown in FIG. 7, for example, by taking a P1 point of interest as a centre, a target area range can be zoomed out or in by closing or opening of two fingers on the touch screen. Records such as a framing image range and image features will be reported to the image analysis processing unit.

An area of interest to the user, embodied in a preview image scenario, is framed. A framing mode includes, but is not limited to, a square or a round, which is highlighted to the user for confirmation. The user explicitly sends out a confirmation signal. If the user quickly and doubly clicks the touch screen, it is regarded that confirmation for locking of a target area is completed. A selection whether to detail and lock objects within the area is provided for the user synchronously. If the user has this demand, for the area, a profile of each object is extracted by means of a shape edge detection algorithm such as a Roberts algorithm, a Sobel algorithm, a Prewitt algorithm, a Krisch algorithm, a Gauss-Laplace algorithm and the like. The profile of each object is highlighted to the user for confirmation. The user confirms one or more object subjects of interest. After the user explicitly sends out a confirmation signal, if the user quickly and doubly clicks the touch screen, it is regarded that confirmation for locking of a target area or a target object is completed. Image feature information about this specific area or a certain specific object subject is stored and reported.

5. Image analysis processing is performed, and multi-frame tracking is performed to lock a target area object.

The image analysis processing unit performs multi-frame tracking to lock a target area or an object subject. Meanwhile, untimed multi-frame processing will be performed herein, an area object is calibrated and locked, and image feature information is stored and updated.

6. A special effect on the target area or the object subject is instantly presented, pre-photographed and stored.

By means of the above steps, a preferred target area or object subject has been determined. Together with different special effect models and picture settings selected and set by the user, the image analysis processing unit will instantly apply a special effect on a target area or object subject of interest to the user, so that a special effect on an object subject in a certain local specific area within a full image of framing in the whole process can be previewed, and a result map is pre-stored periodically. Meanwhile, the special effect is transported to the real-time display and user interaction action acquisition unit and presented in real time.

7. A photograph is taken to obtain a picture result satisfying the special effect on the target area or object subject required by the user.

The user formally takes a photograph, and an obtained picture result is shown in FIG. 8. By taking a certain canned beverage ABC on a desktop as an example, special effects, such as colour adjustment, letter blurring and amplification, operated on a subject object may be instantly achieved, thereby greatly enriching a photographing function and meeting user requirements which rise increasingly and are diversified.

Due to setting of pre-photographing and storage operations in the sixth step, after a formal photographing operation of the user is triggered, a system will analyze whether a current target area or object subject changes with respect to a previous storage record, and if no, a processing effect of the previous operation can be directly applied, thereby greatly reducing the consumption of photographing/shooting time.

In a word, by means of only a simple interaction of the user, diversified, rich, accurate and efficient special photographing/shooting effects on a certain area or a certain object subject in a preview full view can be instantly achieved. Due to continuous tracking locking of target area objects and preview presentation of instant special effects, the phenomenon of bad photographing/shooting effect caused by shaking will be effectively improved.

By means of the image presentation method, the terminal device and the computer storage medium according to the embodiments of the present disclosure, an area target of interest to a user may be locked within a full image of framing in a preview stage, and visual requirements of the user for a real-time special effect on the area target are met in a differentiated and diversified way. The method and the terminal device according to the embodiments of the present disclosure may achieve an innovative expansion of a photographic function mode of a terminal, fill in the blanks of instantly previewing and photographing a special effect on an area target by the terminal, and obtain a new photographic special effect style and an instant image, thereby enriching a photographic experience.

By means of illustrations of implementations, technical means and effects adopted to achieve predetermined purposes in the present disclosure shall be better understood more deeply. However, the accompanying drawings are merely intended to provide references and illustrations, and are not intended to limit the present disclosure.

### INDUSTRIAL APPLICABILITY

By means of the image presentation method and the terminal device according to the embodiments of the present disclosure, an area target of interest to a user may be locked within a full image of framing in a preview stage, and visual requirements of the user for a real-time special effect on the area target are met in a differentiated and diversified way. The method and the terminal device according to the embodiments of the present disclosure may achieve an innovative expansion of a photographic function mode of a terminal, fill in the blanks of instantly previewing and photographing a special effect on an area target by the terminal, and obtain a new photographic special effect style and an instant image, thereby enriching photographic experience.

1. An image presentation method, comprising:
acquiring an area target selected by a user within a picture in a preview stage; and
instantly and continuously presenting the area target selected by the user according to an effect set by the user.

2. The image presentation method according to claim 1, wherein the step of acquiring the area target selected by the user within the picture in the preview stage comprises:
providing an initial area selection frame for the user, and adjusting a position and/or size of the area selection frame according to an operation of the user, wherein a coverage range of the adjusted area selection frame is the area target;
or,
determining a profile of each object subject within a full image of preview framing based on a shape edge detection algorithm to allow the user to select an object subject of interest therefrom, wherein the selected object subject is the area target;
or,
providing an initial area selection frame for the user, adjusting a position and/or size of the area selection frame according to an operation of the user, and then determining a profile of each object subject within a full image of preview framing in the area selection frame based on a shape edge detection algorithm to allow the user to select an object subject of interest therefrom, wherein the selected object subject is the area target.

3. The image presentation method according to claim 2, wherein the step of providing the initial area selection frame for the user comprises:
setting a default position starting point within the picture in the preview stage, moving a position at the starting point to a position point of interest to the user based on the operation of the user or by capturing movement of eyes, gazing at a focus, of the user, and providing the initial area selection frame for the user at the position point of interest to the user.

4. The image presentation method according to claim 1, wherein the step of presenting the area target selected by the user instantly and continuously according to the effect set by the user comprises:
tracking the area target selected by the user in real time by comparing collected image frames, and continuously performing display within the tracked area target according to the effect set by the user.

5. The image presentation method according to claim 4, wherein the step of tracking the area target selected by the user in real time by comparing the collected image frames comprises:
comparing a position of the area target within a current image frame with a position of the area target within a preceding image frame based on the collected continuous image frames so as to track and locate a position change of the area target in real time.

6. The image presentation method according to claim 5, wherein the preceding image frame comprises: a previous frame of image with respect to the current image frame or previous frames of images with respect to the current image frame; and
the current image frame comprises: image frames, selected in the collected continuous image frames as current image frames, at set intervals.

7. The image presentation method according to claim 1, wherein the effect set by the user is in one or more types of: focusing enhancement or fuzzification, overturn or rotation, zooming in or out, replacement or replication, colour removal or addition and photographing parameter setting.

8. The image presentation method according to claim 1, further comprising:
storing and presenting the area target selected by the user according to the effect set by the user based on a trigger operation of the user.

9. The image presentation method according to claim 1, further comprising:
pre-photographing and storing the area target selected by the user in the preview stage at a set time interval according to the effect set by the user, and directly applying, if a difference between a picture photographed by the user and a pre-photographed picture does not exceed a set threshold, the pre-photographed picture as a picture finally photographed by the user.

10. A terminal device, comprising:
an area target selection module, configured to acquire an area target selected by a user within a picture in a preview stage; and
a real-time preview effect presentation module, configured to instantly and continuously present the area target selected by the user according to an effect set by the user.

11. The terminal device according to claim 10, wherein the area target selection module comprises:
an initial area provision module, configured to provide an initial area selection frame for the user; and
an area target determination module, configured to adjust a position and/or size of the area selection frame according to an operation of the user, wherein a coverage range of the adjusted area selection frame is the area target;
or, the area target selection module comprises:
an area target determination module, configured to determine a profile of each object subject within a full image of preview framing based on a shape edge detection algorithm to allow the user to select an object subject of interest therefrom, wherein the selected object subject is the area target;
or, the area target selection module comprises:
an initial area provision module, configured to provide an initial area selection frame for the user; and
an area target determination module, configured to adjust a position and/or size of the area selection frame according to an operation of the user, and determine a profile of each object subject within a full image of preview framing in the area selection frame based on a shape edge detection algorithm to allow the user to select an object subject of interest therefrom, wherein the selected object subject is the area target.

12. The terminal device according to claim 11, wherein the initial area provision module is configured to:
set a default position starting point within the picture in the preview stage, move a position at the starting point to a position point of interest to the user based on the operation of the user or by capturing movement of eyes, gazing at a focus, of the user, and provide the initial area selection frame for the user at the position point of interest to the user.

13. The terminal device according to claim 10, wherein the real-time preview effect presentation module comprises:
a tracking module, configured to track the area target selected by the user in real time by comparing collected image frames; and
a display module, configured to continuously perform display within the tracked area target according to the effect set by the user.

14. The terminal device according to claim 13, wherein the tracking module is configured to:
compare a position of the area target within a current image frame with a position of the area target within a preceding image frame based on the collected continuous image frames so as to track and locate a position change of the area target in real time.

15. The terminal device according to claim 14, wherein the preceding image frame comprises: a previous frame of image with respect to the current image frame or previous frames of images with respect to the current image frame; and
the current image frame comprises: image frames, selected in the collected continuous image frames as current image frames, at set intervals.

16. The terminal device according to claim 10, wherein the effect set by the user is in one or more types of: focusing enhancement or fuzzification, overturn or rotation, zooming in or out, replacement or replication, colour removal or addition and photographing parameter setting.

17. The terminal device according to claim 10, further comprising:
a photographing processing module, configured to store and present the area target selected by the user according to the effect set by the user based on a trigger operation of the user.

18. The terminal device according to claim 10, further comprising:
a photographing processing module, configured to pre-photograph and store the area target selected by the user in the preview stage at a set time interval according to the effect set by the user, and directly apply, if a difference between a picture photographed by the user and a pre-photographed picture does not exceed a set threshold, the pre-photographed picture as a picture finally photographed by the user.

19. A computer storage medium, computer executable instructions being stored therein and being configured to execute an image presentation method, the image presentation method comprising:
acquiring an area target selected by a user within a picture in a preview stage; and
instantly and continuously presenting the area target selected by the user according to an effect set by the user.
